(19) United States
(12) Patent Application Publication
(10) Pub. No.: US 2025/0229963 A1
(43) Pub. Date: Jul. 17, 2025

(54) BIODEGRADABLE PACKAGING MATERIAL, USE AND METHOD FOR MANUFACTURING THEREOF

(71) Applicant: Toraphene Ltd, Exmouth (GB)

(72) Inventors: Gaute Juliussen, Exmouth (GB); Lijie He, Exmouth (GB)

(21) Appl. No.: 18/877,018

(22) PCT Filed: Jun. 28, 2023
(86) PCT No.: PCT/IB2023/056679

§ 371 Date: Dec. 19, 2024

(30) Foreign Application Priority Data
Jun. 30, 2022 (GB) 2209609.3

(51) Int. Cl. B65D 65/46; B32B 9/00; B32B 9/04; B32B 27/20; B32B 37/24

(52) U.S. Cl. CPC B65D 65/466; B32B 9/007; B32B 9/045; B32B 27/20; B32B 37/24; B32B 2037/243; B32B 2264/108; B32B 2264/201; B32B 2307/4023; B32B 2307/7163; B32B 2307/7376; B32B 2307/75; B32B 2313/04; B32B 2439/70

(57) ABSTRACT

In general terms present invention proposes a biodegradable packaging material (100). The biodegradable packaging material comprises an inner layer (102) comprising an enhanced polymeric substrate: an outer layer (104) comprising a printable substrate; and a middle layer (106), arranged between the inner layer and the outer layer, comprising at least one functionalized graphene layer, wherein the biodegradable packaging material is suitable for an anaerobic digestion, when disposed. In general terms present invention also proposes a method for manufacturing the biodegradable packaging material.

### FIELD OF THE INVENTION

This invention relates to a packaging material. In particular, though not exclusively, this invention relates to a biodegradable packaging material, a use thereof and a method for manufacturing thereof.

### BACKGROUND

In present scenario, due to a fast-paced, hectic lifestyle, and developing e-commerce, a demand for packaging materials has been increasing day by day. Moreover, the demand is expected to boost further due to increasing user preferences for convenience. Furthermore, the packaging of materials is of paramount importance in regard with products' quality and safety. Typically, a majority of existing packaging materials are made from petroleum-based plastics, thereby leading to several environmental problems. Notably, of all the produced petroleum-based plastics, only a few percent are recyclable and for the rest discarded waste requires hundreds to thousands of years to decompose.

Over the past decades, use of bioplastic is a potential alternative to conventional plastic packaging material due to a functional similarity thereof. However, not all the bioplastics are biodegradable, nor have positive impact on the environment. In this regard, the bioplastic (such as alginate) is used due to various industrial applications thereof. However, the said bioplastic displays insufficient mechanical properties and barrier properties, thus is inappropriate for packaging of a wide range of materials.

Conventionally, a lamination of pure aluminium layer (99.5%) or an alloy thereof is used for the packaging of materials due to a corrosion resistant and impermeable nature thereof. However, said packaging material is non-recyclable and is less attractive in the countries where metal-free packaging materials are favoured. Moreover, a metal oxide coating may also be used for packaging of materials. However, the use of metal oxide increases the overall toxicity of the packaging material. Furthermore, a sustainable commercialization of the said packaging materials is rare.

Therefore, in the light of the foregoing discussion, there exists a need to overcome the aforementioned drawbacks associated with the existing packaging materials.

### SUMMARY OF THE INVENTION

A first aspect of the invention provides a biodegradable packaging material comprising: an inner layer comprising an enhanced polymeric substrate; an outer layer comprising a printable substrate; and a middle layer, arranged between the inner layer and the outer layer, comprising at least one functionalized graphene layer, wherein the biodegradable packaging material is suitable for an anaerobic digestion, when disposed.

Suitably, the biodegradable packaging material comprises a multi-layered structure, wherein each layer provides advantages in terms of enhanced barrier properties, functional and mechanical properties thereof. Moreover, the biodegradable packaging material is non-toxic and environmentally friendly. Beneficially, the products, such as edible products, enclosed in the biodegradable packaging material are safe for human consumption. Herein, the term “biodegradable packaging material” refers to a material that possesses an ability to degrade quickly and is used for enclosing or protecting products for distribution, storage, sale, and use. In this regard, the biodegradable packaging material is used to identify, describe, display, and promote the product in order to make the product marketable.

The term “inner layer” as used herein refers to a base layer of the biodegradable packaging material that is directly in contact with an item that needs to be packaged. Moreover, the inner level is configured to exhibit strong mechanical properties. Optionally, the mechanical properties may include modulus of elasticity, tensile strength, elongation, hardness, fatigue limit, and so forth. The term “enhanced polymeric substrate” as used herein refers to a substrate of polymer having improved seal strength, integrity, and tolerance for higher temperature as a result of one or more compounds.

In an embodiment, the enhanced polymeric substrate comprises an alginate enhanced using at least one of: a functionalized graphene nanoplatelets, an organic compound, an inorganic nanoparticle, and at least one polymeric substrate. Optionally, the at least one polymeric substrate may be different from the enhanced polymeric substrate.

The term “alginate” as used herein refers to a natural polysaccharide containing β-(1,4)-d-mannuronic acid (M) and α-(1,4)-I-guluronic acid (G) monomers. Notably, the alginate is extracted from seaweeds. Beneficially, the alginate possesses a unique macromolecular structure and ion exchange capacity to selectively bind heavy metal ions due to removal efficiency and adsorption capacity thereof, achieved through a number of active binding sites and functional groups along the polymeric chain. Optionally, the strong binding of the alginate with heavy metal ions adds another significant health benefit to alginate as a functional food ingredient, whereby the addition of the alginate helps to remove heavy metal contamination in the foods as well as in the human body. Optionally, the alginate gels may be widely used in a food industry, a drug delivery and a tissue engineering due to non-toxicity, biocompatibility, biodegradation and cost-effectivity thereof, thereby improving the performance thereof.

Throughout the present disclosure, the term “graphene” refers to a honeycomb planar film formed by sp2 hybridization of carbon atoms, also called graphite. The term “functionalized graphene nanoplatelets” as used herein refers to refers to short stacks of polygonal platelet-shaped graphene sheets in a planar structure. Advantageously, due to a unique size and morphology, the graphene nanoplatelets possess enhanced barrier properties against gas, liquids and plasma (such as aroma or volatile organic compounds) diffusion.

In an embodiment, the graphene nanoplatelets comprises at least one of: graphene, functionalized graphene, doped graphene, graphene oxide, partially reduced graphene oxide, graphite flakes. Optionally, the graphene nanoplatelets are functionalized (such as edge functionalized) with functional groups selected from the group comprising alkyl amines, aromatic amines, functionalized amines, alkanols, other nucleophilic entities, and combinations thereof. Moreover, the functionalized graphene nanoplatelets possess excellent mechanical properties such as toughness, strength, and surface hardness. It will be appreciated that the graphene nanoplatelets comprises the graphene in various forms such as functionalized graphene that comprises a functional group attached thereto, doped graphene that is obtained by exposing graphene to other chemical compounds, and so forth.

Optionally, the enhanced polymeric substrate comprises the organic compound. In some embodiments, the organic compound may be a nano-cellulose, a glycerol, a xanthan, a fructose, and so forth. Optionally, the inorganic nanoparticle may include a biobased material such as a crosslinking agent. In some embodiments, the crosslinking agent may be a copper sulphate (CuSO₄) that is highly soluble in water and therefore is easy to distribute in the environment. Advantageously, the copper sulphate may calcium ions and enable a complete anaerobic digestion of the alginate or the inner layer under controlled conditions. Optionally, the controlled conditions may be a temperature in the range of 25 to 47°C. and/or a pH in a range of 5 to 8 and preferably 7 to 8. The controlled conditions are chosen such that the biological degradation of the alginate is catalysed by an enzyme. Such catalytic process may be a beta-elimination reaction. The enzyme may be a Mannuronate-specific alginate lyase. The enzyme may be found in sources including marine algae, marine molluscs, and microorganisms. For an optimum enzyme activity and thermal stability of the reaction, the temperature range of the range of 25 to 47° C. is preferred and in particular, of 37° C. is preferred. Optionally, the enhanced polymeric substrate comprises the inorganic nanoparticle. Optionally, the inorganic nanoparticle may include a plasticiser. Optionally, the plasticiser may be added to the biodegradable packaging material to increase plasticity, and decrease viscosity thereof. Optionally, the at least one polymeric substrate may be a chitosan, a gelatine, a starch, a polyvinyl alcohol, a pectin, and so forth. Optionally, the inner layer may possess good seal ability and thermal stability.

Throughout the present disclosure, the term “outer layer” refers to a topmost layer of the biodegradable packaging material having the printable substrate associated therewith. Typically, the outer layer is exposed to environment external to the packaged item. In an embodiment, the printable substrate is at least one of: paper, cellulose, wood, cardboard, biodegradable plastic. Advantageously, the outer layer is robust. Suitably, the material used in the fabrication of the aforementioned printable substrates is abundant, cost-effective, and easy to process. Optionally, the aforementioned printable substrates enhance the mechanical strength, stability and print-ability of the biodegradable packaging material.

Throughout the present disclosure, the term “middle layer” refers to layers that exist between the inner layer and the outer layer of the biodegradable packaging material and comprising at least one functionalized graphene layer. Advantageously, the at least one functionalized graphene layer is robust and possesses improved barrier properties. Optionally, the one or more layers of the functionalized graphene layer may be partially oxidized to provide oxygen groups on the edges to enhance bonding strength with the at least one polymeric substrate. Optionally, the functionalized graphene layer may aid in the thermal stability of the biodegradable packaging material. Optionally, the inner layer may be applied directly onto the middle layer without requiring any layer of adhesive thereupon. Optionally the middle layer, containing the functionalized graphene, which is electrically conductive, may be used as, or modified in a way to obtain one of: an intelligent material, an active material, a reactive material, a multi-functional material, a sensory material (sensor), a conductive material or a tunable sensory metamaterial for implant.

In an embodiment, the inner layer has a thickness ranging from 10 μm to 100 μm. Optionally the thickness of the inner layer of the biodegradable packaging material may be in a range from 10 μm to 20 μm, or 10 μm to 30 μm, or from 10 μm to 40 μm, or from 10 μm to 50 μm, or from 10 μm to 60 μm, or from 10 μm to 70 μm, or from 10 μm to 80 μm, or from 10 μm to 90 μm or, or from 10 μm to 100 μm, or from 20 μm to 30 μm, or from 20 μm to 40 μm, or from 20 μm to 50 μm, or from 20 μm to 60 μm, or from 20 μm to 70 μm, or from 20 μm to 80 μm, or from 20 μm to 90 μm, or from 20 μm to 100 μm, or from 30 μm to 40 μm, or from 30 μm to 50 μm, 30 μm to 60 μm, or from 30 μm to 70 μm, or from 30 μm to 80 μm, or from 30 μm to 90 μm, or from 30μm to 100 μm, or from 40 μm to 50 μm, or from 40 to 60 μm, or from 40 μm to 70 μm, or from 40 μm to 80 μm, or from 40 μm to 90 μm, or from 40 μm to 100 μm, or from 50 to 60 μm, or from 50 μm to 70 μm, or from 50 μm to 80 μm, or from 50 μm to 90 μm, or from 50 μm to 100 μm, or from 60 μm to 70 μm, or from 60 μm to 80 μm, or from 60 μm to 90 μm, or from 60 μm to 100 μm, or from 70 μm to 80 μm, or from 70 μm to 90 μm, or from 70 μm to 100 μm, or from 80 μm to 90 μm, such as from 90 μm to 100 μm.

In an embodiment, the middle layer has a thickness ranging from 10 nm to 100 nm. Suitably, the said thickness range provides high barrier properties against moisture, oxygen, grease, aromatics (plasma), flavour, light, and so forth. Advantageously, the thickness of middle layer may be influenced by different coating methods. For instance, the layer made by a brush painting may exhibit a thickness inferior to 1 μm; the layer made by a vacuum filtration method may exhibit a thickness of a few micrometres. Optionally the thickness of the middle layer of the biodegradable packaging material may be in a range from 10 nm to 20 nm, or 10 nm to 30 nm, or from 10 nm to 40 nm, or from 10 nm to 50 nm, or from 10 nm to 60 nm, or from 10 nm to 70 nm, or from 10 nm to 80 nm, or from 10 nm to 90 nm or, or from 10 nm to 100 nm, or from 20 nm to 30 nm, or from 20 nm to 40 nm, or from 20 nm to 50 nm, or from 20 nm to 60 nm, or from 20 nm to 70 nm, or from 20 nm to 80 nm, or from 20 nm to 90 nm, or from 20 nm to 100 nm, or from 30 nm to 40 nm, or from 30 nm to 50 nm, or from 30 nm to 60 nm, or from 30 nm to 70 nm, or from 30 nm to 80 nm, or from 30 nm to 90 nm, or from 30 nm to 100 nm, or from 40 nm to 50 nm, or from 40 to 60 nm, or from 40 nm to 70 nm, or from 40 nm to 80 nm, or from 40 nm to 90 nm, or from 40 nm to 100 nm, or from 50 nm to 60 nm, or from 50 nm to 70 nm, or from 50 nm to 80 nm, or from 50 nm to 90 nm, or from 50 nm to 100 nm, or from 60 nm to 70 nm, or from 60 nm to 80 nm, or from 60 nm to 90 nm, or from 60 nm to 100 nm, or from 70 nm to 80 nm, or from 70 nm to 90 nm, or from 70 nm to 100 nm, or from 80 nm to 90 nm, such as from 90 nm to 100 nm. Optionally, the said thickness range of the middle layer enables the one or more layers of the middle layer to lay flat onto the surface of each other.

In an embodiment, the biodegradable packaging material is fabricated using a coextrusion technique, a roll-to roll or a lamination technique, a co-injection technique and a coating technique. The term “coextrusion technique” as used herein refers to a process in which two or more polymer materials are extruded together to produce different multilayer structures. Advantageously, the coextrusion technique enables each layer of the biodegradable packaging material to impart a desired characteristic such as stiffness, heat-seal-ability, impermeability, or resistance to a particular environment. The term “lamination technique” as used herein refers to a process of manufacturing a material having multiple layers, so that the composite material achieves improved strength, stability, liquid/gas barrier, sound insulation, appearance, or other properties. The term “co-injection technique” as used herein refers to a process in which two different materials, such as polymers, are formed into a laminar structure. Advantageously, the co-injection technique provides a good precision. The term “coating technique” as used herein refers to a process of applying a coating to the surface of an object or a substrate. Optionally, coating technique may be used to change the surface properties of the substrate, such as adhesion, wettability, corrosion resistance, or wear resistance.

In an embodiment, the coating technique comprises a solvent coating between the middle layer and the outer layer of the biodegradable packaging material. The term “solvent coating” as used herein refers to a process of applying a coating of a solvent to a moving web of flexible substrate. In this regard, the substrate may be the middle layer and the outer layer of the biodegradable packaging material. In an implementation, the solvent coating is applied between the middle layer and the outer layer of the biodegradable packaging material. Beneficially, the solvent coating enhances the function or the nature of the graphene. Moreover, the solvent coating reduces or eliminates the need of adhesive, linker or any other tie layer between the middle layer and the outer layer, thereby allowing the middle layer to be applied directly on the outer layer of the biodegradable packaging material with excellent adhesive stability. In some embodiments, based on an application of the biodegradable packaging material, the concentration of the solvent may be varied in order to manipulate the thickness of the middle layer and the outer layer.

Moreover, the biodegradable packaging material is suitable for an anaerobic digestion, when disposed. Optionally, the anaerobic digestion may take place in a reactor where the biodegradable packaging material is turned into water, mulch (nutritious compost) and methane gas, that may be used to make “green” power or PHA polymers.

A second aspect of the invention provides a use of the biodegradable packaging material according to aforementioned biodegradable packaging material, as a non-food packaging or a dry-food packaging. Herein, the non-food may be in a powdered form, solid form or liquid form; and the dry-food may be in powdered or moisture-less solid form.

Suitably, the biodegradable packaging material as disclosed above may be used as the non-food packaging or the dry food packaging. Advantageously, the said non-food packaging or a dry-food packaging may be later suitable for biodegradation or composting in soil or water or for the anaerobic digestion.

In an embodiment, the non-food packaging or a dry-food packaging is implemented as a bag, a container, a pouch, a sachet, or a laminate. In this regard, the non-food packaging or the dry-food packaging may be implemented as a semi-rigid carton or paper bags, pouches, sachets, containers, and so forth. It will be appreciated that the bag, the container, the pouch and the laminate are designed to maintain a structural integrity of the packaged item therein.

A third aspect of the invention provides a method for manufacturing the biodegradable packaging material according to aforementioned biodegradable packaging material, the method comprising: manufacturing an inner layer comprising an enhanced polymeric substrate; manufacturing a middle layer comprising at least one functionalized graphene layer; manufacturing an outer layer comprising a printable substrate; and assembling the inner layer, the middle layer and the outer layer such that the middle layer is arranged between the inner layer and the outer layer, wherein the biodegradable packaging material is suitable for an anaerobic digestion, when disposed.

In an embodiment, the step of manufacturing the inner layer comprises
obtaining a graphene oxide aqueous dispersion solution;
mixing an alginate solution and an organic compound with the graphene oxide aqueous dispersion solution;
adding an inorganic nanoparticle and at least one polymeric substrates to the functionalized alginate solution to obtain the enhanced polymeric substrate; and
stirring the enhanced polymeric substrate for around 2-3 hours.

Suitably, the graphene aqueous dispersion is obtained by prolonged sonication prior mixing, with graphene dispersed at the level of monolayer. Moreover, the alginate solution and the nanocellulose are added into the graphene oxide aqueous dispersion solution by shear mixing. It will be appreciated that due to the oxygen functional groups of graphene (such as hydroxyl, epoxide, and carbonyl groups) and the hydrophilicity of nanocellulose, a well disperse aqueous solution of the alginate mixture is obtained in the end. Beneficially, for further enhancement, the inorganic nanoparticle and at least one other polymeric substrate is applied into the resulted alginate solution.

The term “mixing” as used herein refers to a unit operation that involves manipulation of a heterogeneous physical system into a homogeneous solution. In this regard, the alginate solution and the organic compound are mixed with the graphene oxide aqueous dispersion solution to form a mixture thereof. Moreover, an inorganic nanoparticle and at least one polymeric substrate are added to the functionalized alginate solution to obtain the enhanced polymeric substrate. Additionally, the enhanced polymeric substrate is stirred for around 2-3 hours. Optionally, the stirring may occur for 2.5 hours.

In an embodiment, a concentration of the graphene oxide aqueous dispersion solution is in a range of 1-5 mg/ml, a concentration of the organic compound is in a range of 1-5 mg/ml, a concentration of the alginate solution is in a range of 2-4% w/w, a concentration of the inorganic nanoparticle is in a range of 20-40% w/w of the alginate solution, and a concentration of the polymeric substrates is in a range of 5-10% w/w of the alginate solution.

Suitably, the aforementioned concentrations of the graphene oxide aqueous dispersion solution and the organic compound provide an optimal enhancement in both the barrier and the mechanical properties of the biodegradable packaging material. It will be appreciated that the aforementioned concentrations allow to overcome mechanical stiffness. Moreover, the optimal concentration of the organic compound may result in the formation of a final robust biodegradable packaging material.

Optionally, the concentration of the graphene oxide aqueous dispersion solution may be in a range from 1 mg/ml to 2 mg/ml, or 1 mg/ml to 3 mg/ml, or from 1 mg/ml to 4 mg/ml, or from 1 mg/ml to 5 mg/ml, or from 2 mg/ml to 3 mg/ml, or from 2 mg/ml to 4 mg/ml, or from 2 mg/ml to 5 mg/ml, or from 3 mg/ml to 4 mg/ml, or from 3 mg/ml to 5 mg/ml, such as from 4 mg/ml to 5 mg/ml.

Optionally, the concentration of the alginate solution may be in a range from 2-4 wt % 2 wt % to 2.5 wt %, or 2 wt % to 3 wt %, or from 2 wt % to 3.5 wt %, or from 2 wt % to 4 wt %, or from 3 wt % to 3.5 wt %, such as from 3 wt % to 4 wt %.

Optionally, the concentration of the organic compound may be in a range from 1 mg/ml to 2 mg/ml, or 1 mg/ml to 3 mg/ml, or from 1 mg/ml to 4 mg/ml, or from 1 mg/ml to 5 mg/ml, or from 2 mg/ml to 3 mg/ml, or from 2 mg/ml to 4 mg/ml, or from 2 mg/ml to 5 mg/ml, or from 3 mg/ml to 4 mg/ml, or from 3 mg/ml to 5 mg/ml, such as from 4 mg/ml to 5 mg/ml.

Optionally, the concentration of the inorganic nanoparticle may be in a range from 20% w/w to 25% w/w, or from 20% w/w to 30% w/w, or from 20% w/w to 35% w/w, or from 20% w/w to 40% w/w, or from 25% w/w to 30% w/w, or from 25% w/w to 35% w/w, or from 25% w/w to 40% w/w, or from 30% w/w to 35% w/w, or from 30% w/w to 40% w/w, such as from 35% w/w to 40% w/w of the alginate solution.

Optionally, the concentration of the polymeric substrates is in a range from 5% w/w to 6% w/w, or from 5% w/w to 7% w/w, or from 5% w/w to 8% w/w, or from 5% w/w to 9% w/w, or from 5% w/w to 10% w/w, or from 6% w/w to 7% w/w, or from 6% w/w to 8% w/w, or from 6% w/w to 9 w/w %, or from 6% w/w to 10% w/w, or from 7% w/w to 8% w/w, or from 7% w/w to 9% w/w, or from 7% w/w to 10% w/w, or from 8% w/w to 9% w/w, or from 8% w/w to 10% w/w, such as from 9% w/w to 10% w/w of the alginate solution

In an embodiment, the step of manufacturing the middle layer comprises
dispersing graphene nanoplatelets in an organic solvent by sonicating for 20-40 hours; and
adding a stabilizing agent to the graphene nanoplatelets dispersion solution, and sonicating the resultant mixture for 1-2 hours to obtain a stable graphene ink dispersion.

Suitably, the stabilizing agent may be an ethyl cellulose. It will be appreciated that the ethyl cellulose is a derivative of cellulose in which some of the hydroxyl groups on the repeating glucose units are converted into ethyl ether groups. Advantageously, the ethyl cellulose is non-toxic films and water insoluble, thus may be used to safeguard ingredients, inside the biodegradable packaging material, from moisture.

Notably, apart from its excellent mechanical properties (such as tensile strength, and so on) graphene is well known for its high impermeability, thus the middle layer comprising graphene nanoplatelets exhibits excellent barrier properties against moisture/water, oxygen, grease, aromatics (plasma), flavor, and light.

Herein, the term “sonicating” refers to a process of applying sound energy to agitate particles or discontinuous fibres in a liquid. In this regard, the particles of the graphene nanoplatelets and the organic solvent are agitated using the sound energy in order to disperse the graphene nanoplatelets in the organic solvent. Optionally, the sonication may be conducted using either an ultrasonic bath or an ultrasonic probe using an ultrasonic frequency (>20 kHz). Moreover, the particles of the graphene nanoplatelets and the organic solvent are sonicated for 20-40 hours. Optionally, the sonicating may occur from 20 hours to 25 hours, or from 20 hours to 30 hours, or from 20 hours to 35 hours, or from 20 hours to 40 hours, or from 25 hours to 30 hours, or from 25 hours to 35 hours, or from 25 hours to 40 hours, or from 30 hours to 35 hours, or from 30 hours to 40 hours, such as from 35 hours to 40 hours.

Furthermore, the stabilizing agent is added to the graphene nanoplatelets dispersion solution, and the resultant mixture is sonicated for 1-2 hours to obtain the stable graphene ink dispersion. Herein, the step of manufacturing the middle layer results in the formation of the graphene ink dispersion as an end result. Optionally, the graphene ink dispersion may be a coating of the middle layer of the biodegradable packaging material. Optionally, the graphene ink dispersion may also switch solvent by adding a new solvent while boiling up the excitant solvent. Optionally, the organic solvent may be a dimethylformamide (DMF), an ethyl acetate, an N-Methyl-2-pyrrolidone (NMP), a chloroform, a dichloromethane, a Cyrene, and so forth. It will be appreciated that the aforementioned organic solvent possesses good solvency properties to dissolve a wide range of polymers. Optionally, the Cyrene possesses a beneficial occupational health and safety profile combined with good biodegradability without NOₓ or SOₓ production.

In an embodiment, the step of manufacturing the outer layer comprises
obtaining a printable substrate; and
applying at least one layer of the graphene ink dispersion on the printable substrate, wherein a subsequent layer of the graphene ink dispersion is applied when a previous layer of the graphene ink dispersion is set.

In this regard, the printable substrate is obtained and at least one layer of the graphene ink dispersion is applied thereon. Moreover, the subsequent layer of the graphene ink dispersion is applied when a previous layer of the graphene ink dispersion is set. The aforementioned steps result in the formation of the outer layer of the biodegradable packaging material.

In an embodiment, the step of applying at least one layer of the graphene ink dispersion on the printable substrate is achieved by any one of: brush painting, ink-jet printing, spread coating, dip-coating, vacuum filtration, or a combination thereof.

Suitably, the aforementioned step may produce a relatively thick coating, with a thickness ranging from 1-10 μm on the printable substrate. Optionally, the aforementioned step may also enable the production of a single-standing layer of the graphene. Optionally, the aforementioned techniques of application of the graphene ink may provide a homogeneous surface to the biodegradable packaging material. The term “brush painting” as used herein refers to a process of painting a coating material on a substrate. The term “ink-jet printing” as used herein refers to a computer printing process that recreates a digital image by propelling droplets of ink onto a substrate. The term “dip-coating” as used herein refers to a process of immersing a substrate into a tank containing coating material, removing the coated substrate from the tank, and draining thereof. The term “spread-coating” as used herein refers to a process by which a coating material is dissolved in a solvent and is then spread onto the substrate and heated to evaporate the solvent and leave the coated substrate behind. The term “vacuum filtration” as used herein refers to a process for producing various graphene compounds such as graphene oxide, graphene nanoplatelet, functionalized graphene, and so forth by using a membrane. In this regard, optionally, the at least one layer of the graphene ink dispersion may be filtered through a porous substrate such as the printable substrate, where a vacuum is forced at the other side of a filter. Optionally, the pressure gradient directs the at least one layer of the graphene ink dispersion flow through the printable substrate that deposits the at least one layer of the graphene ink dispersion. Beneficially, alternatively, the vacuum filtration may produce a relatively thick coating, with a thickness ranging from 1-10 μm.

Optionally, a single-standing layer of the graphene ink may also be produced using the aforementioned step. Optionally, the graphene ink dispersion may also be printed on an un-treated glass surface, the resulted coating may be applied as conductive thin film. Optionally, one or more layers of the graphene ink dispersion may be applied when the first layer thereof is set.

In an embodiment, the step of assembling the inner layer, the middle layer and the outer layer comprises
applying the enhanced polymeric substrate on the graphene ink dispersion layered printable substrate to obtain a printed enhanced polymeric substrate film;
spraying an aqueous solution of a crosslinking agent onto the printed enhanced polymeric substrate film; and
rinsing and drying at room temperature the coated printed enhanced polymeric substrate film to obtain the biodegradable packaging material.

Advantageously, the inner layer, the middle layer and the outer layer of the biodegradable packaging material are assembled together to form a semi-rigid packaging. In this regard, the enhanced polymeric substrate is applied on the graphene ink dispersion layered printable substrate to obtain a printed enhanced polymeric substrate film. Moreover, an aqueous solution of crosslinking agent as described above is sprayed onto the printed enhanced polymeric substrate film. The crosslinking agent is sprayed in a molar concentration of 1M. Furthermore, the coated printed enhanced polymeric substrate film is subjected to rinsing and drying at room temperature to obtain the biodegradable packaging material.

In an embodiment, the step of applying the enhanced polymeric substrate on the graphene ink dispersion layered printable substrate is achieved by any one of: rod-coating, dip-coating, spin-coating, spread-coating, or a combination thereof.

The term “rod-coating” as used herein refers to is a process of applying a coating material on a substrate using a rod. Optionally, the rod may be a stainless-steel rod, that is coiled with a stainless-steel wire. The term “spin-coating” as used herein refers to a process of applying a uniform film of coating material onto a substrate by using a centrifugal force and requires a liquid-vapor interface. In an implementation, the coating material used in the aforementioned techniques is the enhanced polymeric substrate and the substrate is the graphene ink dispersion layered printable substrate.

In an embodiment, the method comprises fabricating the biodegradable packaging material using a coextrusion technique, a roll to roll or a lamination technique, a co-injection technique and a coating technique. Beneficially, the said fabrication techniques enable the biodegradable packaging material to possess a multi-layer structure.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 is a schematic illustration of a biodegradable packaging material, in accordance with an embodiment of the invention; and

FIG. 2 is a flowchart of steps of a method for manufacturing the biodegradable packaging material, in accordance with an embodiment of the invention.

### DETAILED DESCRIPTION

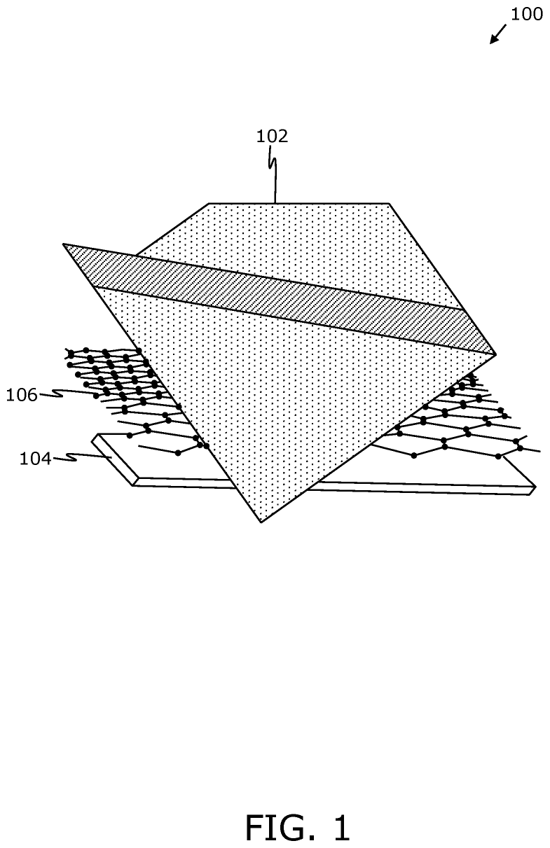

Referring to FIG. 1, shown is a schematic illustration of a biodegradable packaging material 100, in accordance with an embodiment of the invention. The biodegradable packaging material 100 comprises an inner layer 102 comprising an enhanced polymeric substrate (not shown), an outer layer 104 comprising a printable substrate (not shown); and a middle layer 106, arranged between the inner layer 102 and the outer layer 104, comprising at least one functionalized graphene layer (not shown).

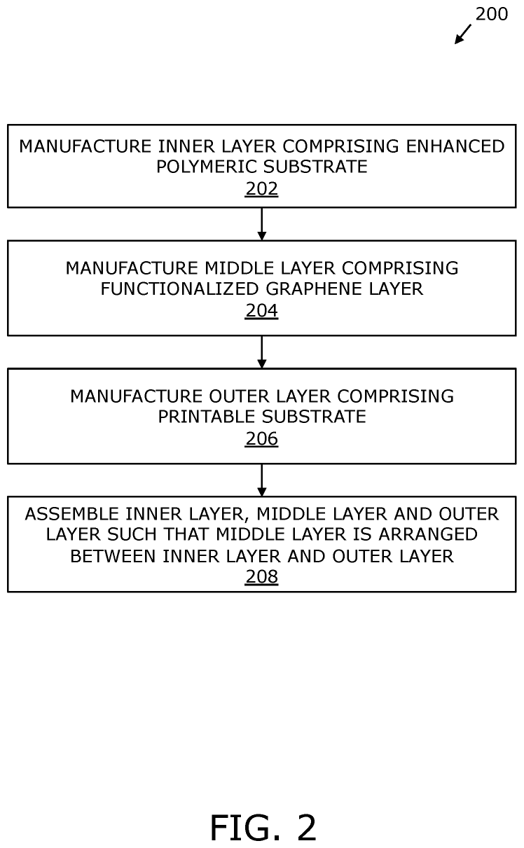

Referring to FIG. 2, shown is a flowchart 200 of steps of a method for manufacturing the biodegradable packaging material, in accordance with an embodiment of the invention. At step 202, an inner layer comprising an enhanced polymeric substrate is manufactured. At step 204, a middle layer comprising at least one functionalized graphene layer is manufactured. At step 206, an outer layer comprising a printable substrate is manufactured. At step 208, the inner layer, the middle layer and the outer layer is assembled such that the middle layer is arranged between the inner layer and the outer layer.

The steps 202, 204, 206, and 208 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1-18. (canceled)

19-36. (canceled)

37. A biodegradable packaging material (100) comprising:
an inner layer (102) comprising a polymeric substrate wherein the polymeric substrate comprises an alginate mixed with functionalized graphene nanoplatelets;
an outer layer (104) comprising a printable substrate; and
a middle layer (106), arranged between the inner layer and the outer layer, comprising at least one functionalized graphene layer, wherein the biodegradable packaging material is suitable for an anaerobic digestion, when disposed, wherein the biodegradable packaging material is implemented in a non-food packaging or a dry-food packaging.

38. The biodegradable packaging material (100) according to claim 37, wherein the alginate is further mixed with an organic compound, inorganic particles. or an organic compound and inorganic particles.

39. The biodegradable packaging material (100) according to claim 37, wherein the functionalized graphene nanoplatelets comprises graphene nanoplatelets with functional groups selected from the group comprising alkyl amines, aromatic amines, functionalized amines, alkanols, other nucleophilic entities, and combinations thereof.

40. The biodegradable packaging material (100) according to claim 37, wherein the inner layer (102) having a thickness ranging from 10 μm to 100 μm.

41. The biodegradable packaging material (100) according to claim 37, wherein the middle layer (106) having a thickness ranging from 10 nm to 100 nm.

42. The biodegradable packaging material (100) according to claim 37, wherein the printable substrate is at least one of: paper, cellulose, wood, cardboard, biodegradable plastic.

43. The biodegradable packaging material (100) according to claim 37, wherein the biodegradable packaging material is fabricated using a coextrusion technique, a lamination technique, a co-injection technique and a coating technique.

44. Use of the biodegradable packaging material (100) according to claim 37, as a non-food packaging or a dry-food packaging.

45. The use of biodegradable packaging material (100) according to claim 37, wherein the non-food packaging or the dry-food packaging is implemented as a bag, a container, a pouch or a laminate.

46. A method for manufacturing the biodegradable packaging material (100), the method comprising:
manufacturing an inner layer (102) comprising an polymeric substrate;
manufacturing a middle layer (106) comprising at least one functionalized graphene layer;
manufacturing an outer layer (104) comprising a printable substrate; and
assembling the inner layer, the middle layer and the outer layer such that the middle layer is arranged between the inner layer and the outer layer,
wherein the biodegradable packaging material is suitable for an anaerobic digestion, when disposed.

47. The method according to claim 46, wherein the step of manufacturing the inner layer (102) comprises:
obtaining a graphene oxide aqueous dispersion solution;
mixing an alginate solution and an organic compound with the graphene oxide aqueous dispersion solution;
adding an inorganic nanoparticle and at least one polymeric substrates to the functionalized alginate solution to obtain the polymeric substrate; and
stirring the polymeric substrate for around 2-3 hours.

48. The method according to claim 46, wherein a concentration of the graphene oxide aqueous dispersion solution is in a range of 1-5 mg/ml, a concentration of the organic compound is in a range of 1-5 mg/ml, a concentration of the alginate solution is in a range of 2-4% w/w, a concentration of the inorganic nanoparticle is in a range of 20-40% w/w of the alginate solution and a concentration of the polymeric substrates is in a range of 5-10% w/w of the alginate solution.

49. The method according to claim 46, wherein the step of manufacturing the middle layer (106) comprises:
dispersing graphene nanoplatelets in an organic solvent by sonicating for 20-40 hours; and
adding a stabilizing agent to the graphene nanoplatelets dispersion solution, and sonicating the resultant mixture for 1-2 hours to obtain a stable graphene ink dispersion.

50. The method according to claim 46, wherein the step of manufacturing the outer layer (104) comprises:
obtaining a printable substrate; and
applying at least one layer of the graphene ink dispersion on the printable substrate, wherein a subsequent layer of the graphene ink dispersion is applied when a previous layer of the graphene ink dispersion is set.

51. The method according to claim 46, wherein the step of applying at least one layer of the graphene ink dispersion on the printable substrate is achieved by any one of: brush painting, ink-jet printing, spread coating, dip-coating, vacuum filtration, or a combination thereof.

52. The method according to claim 46, wherein the step of assembling the inner layer (102), the middle layer (106) and the outer layer (104) comprises:
applying the polymeric substrate on the graphene ink dispersion layered printable substrate to obtain a printed polymeric substrate film;
spraying an aqueous solution of a crosslinking agent onto the printed polymeric substrate film; and
rinsing and drying at room temperature the coated printed polymeric substrate film to obtain the biodegradable packaging material (100).

53. The method according to claim 46, wherein the step of applying the polymeric substrate on the graphene ink dispersion layered printable substrate is achieved by any one of: rod-coating, dip-coating, spin-coating, spread-coating, or a combination thereof.

54. The method according to claim 46, wherein the method comprises fabricating the biodegradable packaging material (100) using a coextrusion technique, a lamination technique, a co-injection technique and a coating technique.
